(19) United States
(12) Patent Application Publication
(10) Pub. No.: US 2007/0213010 A1
(43) Pub. Date: Sep. 13, 2007

(54) SYSTEM, DEVICE, DATABASE AND METHOD FOR INCREASING THE CAPACITY AND CALL VOLUME OF A COMMUNICATIONS NETWORK

(76) Inventor: Alon Konchitsky, Cupertino, CA (US)

Correspondence Address: PERKINS COIE LLP, P.O. BOX 2168, MENLO PARK, CA, 94026, US

(21) Appl. No.: 11/383,906

(22) Filed: May 17, 2006

Related U.S. Application Data
(60) Provisional application No. 60/767,222, filed on Mar. 13, 2006.

(51) Int. Cl. H04B 1/00

(52) U.S. Cl. 455/63.1

(57) ABSTRACT

Capacity of cellular telephone network is increased by using database to record number of callers using low data rate equipment, such as noise reducing or canceling equipment. Use of noise reduction telephones leads to increase in SNR which allows greater number of users. As number of low data rate communications devices, such as noise reduction cellular telephones increases on network and replace higher data rate devices, capacity of network increases as compared to a network that has greater number of higher data rate devices, and number of allowed calls on network may be increased. Business method for operating network, such as a cellular telephone network, that increase revenues and profitability of network as result of increasing network capacity without increasing network infrastructure. Database alone and in combination with cellular device and network used to identify and track number of cellular telephone users who are using low data rate equipment.

### RELATED APPLICATIONS

This application claims the benefit of priority under 35 U.S.C. 119(e) and/or 35 U.S.C. 120 to U.S. patent application Serial Nos.: U.S. Provisional Patent Application Ser. No. 60/767,222 filed 13 Mar. 2006 entitled Noise Canceling Method, Apparatus, And Database For Increasing The Volume Of Calls In A Cellular Network; U.S. patent application Ser. No. 11/402,405 (Attorney Docket No. 60819-8001.US01) filed 11 Apr. 2006 and entitled Method and Apparatus to Improve Voice Quality of Cellular Calls by Noise Reduction Using a Microphone Receiving Noise and Speech from Two Air Pipes; U.S. patent application Ser. No. 11/402,521 (Attorney Docket No. 60819-8002.US01) filed 11 Apr. 2006 and entitled Environmental Noise Reduction and Cancellation for a Voice Over Internet Packets (VOIP) Communication Device; and U.S. patent application Ser. No. 11/402,459 (Attorney Docket No. 60819-8003.US01) filed 11 Apr. 2006 and entitled Environmental Noise Reduction and Cancellation for a Cellular Telephone Communication Device; each of which patent application is hereby incorporated by reference.

### FIELD OF THE INVENTION

The present invention relates generally to voice communication systems, devices, telephones, and methods, and more specifically, to systems, devices, and methods that reduce or cancel ambient or environmental noise that is mixed with voice prior to sending the voice communication over communication links, such as cellular telephone networks, and to signal transmission bandwidth reductions and cellular network call volume and/or system and network capacity increases that can result from such noise reduction or cancellation when linked to database information identifying the device as a low-noise device. The invention also relates to a business method for operating a communication network, such as a cellular telephone network, that increase revenues and profitability of the network as a result of increasing network capacity without increasing network infrastructure. The invention also relates to a database alone and in combination with a cellular handset and network that is used to identify and track the number of cellular telephone users who are using noise reduction equipment on the network.

### BACKGROUND

Voice communication systems and devices such as cellular telephones and wireless telephones, cordless telephones, and communications devices of other types have become ubiquitous; they show up in almost every environment. These systems and devices and their associated communication methods are referred to by a variety of names, such as but not limited to, cellular telephones, cell phones, mobile phones, cordless telephones, wireless telephones in the home and the office, and devices such as personal data assistants (PDAs) that include a wireless or cellular telephone communication capability.

They are used in the home, at the office, in the car, on a train, at the airport, at the beach, at restaurants and bars, on the street, and almost any other imaginable venue. As might be expected, these diverse environments have relatively higher and lower levels of background, ambient, or environmental noise. For example, there is generally less noise in a quiet home than there is in a crowded bar. This noise is picked up by the microphone of the communications device and if at sufficient levels, degrades the intended voice communication. Furthermore, even though the user of the device (caller and/or call receiver) is possibly not aware of the fact, the call when using certain network architectures uses more signaling bandwidth or network capacity because sampling and/or transmission occurs at a higher data rate than is necessary for the call, especially during non-speech segments of the two-way conversation when a user is not speaking at his or her telephone but rather either listening to the other party or during periods of mutual non-speech. The noise therefore results in under utilization of network capacity, even for a fixed voice quality.

It is known that a cellular network is a radio network made up of a number of radio cells (or just cells) each served by a fixed transmitter, normally known as a base station. These cells are used to cover different geographical areas in order to provide radio coverage over a wider geographical area than the area of one cell. Cellular networks are inherently asymmetric with a set of fixed main transceivers each serving a cell and a set of distributed (generally, but not always, mobile) transceivers (e.g., cellular telephones) which provide services to the network's users or callers/receivers.

The primary requirement for a cellular network is that the each of the distributed stations need to distinguish signals from their own transmitter from the signals from other transmitters. There are two common solutions to this requirement, frequency division multiple access (FDMA) and code division multiple access (CDMA). These two common solutions are known in the art and only described here for the purpose of understanding the limitations and shortcomings in the prior art and the benefits provided by the invention.

FDMA works by using a different frequency for each neighboring cell. By tuning to the frequency of a chosen cell, the distributed stations can avoid the different frequency signal from other neighboring cells. The principle of CDMA is somewhat more complex, but achieves the same result, that is, the distributed transceivers can select one cell and listen to it. Other available methods of multiplexing such as polarization division multiple access (PDMA) and time division multiple access (TDMA) cannot generally be used to separate signals from one cell to the next cell since the effects of both PDMA and TDMA vary with position, making signal separation difficult and practically impossible. Orthogonal frequency division multiplex (OFDM) in principal, consists of signaling with frequencies orthogonal to each other. Time division multiple access, however, is used in combination with either FDMA or CDMA in a number of systems to give multiple channels within the coverage area of a single cell.

In the case of a typical taxi cab company and the radio dispatch of taxi cabs, each cab radio has a selector knob or button. The knob or button acts as a channel selector and allows the radio to be tuned to different frequencies. As the drivers and their vehicles move around a geographic area, they change from channel to channel. The drivers know which frequency covers approximately what area, and when they don't get a signal from the previously selected transmitter, they may typically also try and tune to other channels until they find one which works or on which they are able to receive or monitor communications in their local area. Usually, the taxi drivers only speak one at a time, as invited by the operator or according to voice traffic on the channel, in a sense time division multiplexed system.

The wireless world comprises the following exemplary, but not limited communication schemes: time based and code based. In the cellular mobile environment these techniques are named under TDMA (time division multiple access) which comprises but not limited to the following standards GSM, GPRS, EDGE, IS-136, PDC, and the like; and CDMA (code division multiple access) which comprises but not limited to the following standards: CDMA one, IS-95A, IS-95B, CDMA 2000, CDMA 1xEvDv, CDMA 1xEvDo, WCDMA, UMTS, TD-CDMA, TD-SCDMA, OFDM, WiMax, WiFi, and others).

For the code division based standards or orthogonal frequency division, as the number of subscribers grows and average minutes per month increase, more and more mobile calls typically originate and terminate in noisy environments. The ambient background noise does more than degrade voice quality; it also impacts and reduces the maximum number of calls (call volume) that can be supported on the network at any give time and the total network capacity.

In the code division cellular network for example, the voice code data rate is determined by an algorithm which designed to select “Rate 1” or full data rate (9.6 kbps) for speech and “Rate ⅛” or one-eighth data rate (1.2 kbps) for non-speech portions of the communication. Non-speech portions of the communications at each end of the communication would include for example, periods of time where the user at that end is listening and not speaking. The “Rate 1” data code rate would normally provide the highest fidelity speech, whereas the “Rate ⅛” may not provide adequate fidelity to understand the speaker. Other rates such as “Rate ½” (4,8 kbps) or “Rate ¼” (2.4 kbps) present similar compromises such that generally, it is best to use the lowest possible data rate for a non-speech portion of the communication and the highest or at least a relatively high data code rate for speech portions. In some instances, a “Rate ½” transmission may be acceptable, and even a reduction in non-speech portions of the conversation at the “Rate ¼” data code rate may be acceptable. Speaking and non-speaking portions may occur at one or both ends of a normal conversation. Unfortunately, impairments such as background, ambient, or environmental noise not relevant to the conversation are often misinterpreted by the rate determination algorithm within the system (typically within the circuits, logics, and software/firmware of the cellular handset) as voice, so that the “Rate 1” (9.6 kbps) rate appropriate for speech is used for the non-speech portion rather than the more appropriate lower “Rate ⅛” (1.2 kbps) rate that is intended to be used for non-speech (e.g., background noise only without speech). The use of a higher data code rate than required results in consuming unnecessary network bandwidth and decreasing network capacity.

Even where the lower data rate is used for portions of the non-speech portions, certain types of noise that enter the cellular telephone handset microphone may at least initially appear to be a speech signal that causes the rate to be switched to a higher rate and then back to a lower rate. These rate switching incidents also result both higher mean and median data rates during non-speech portions and decreased network capacity and supportable call volume. Other systems and communications standards, schemes, and protocols that provide for variable data rates may typically suffer from the same or analogous limitations.

For the time based schemes, like GSM or GPRS or Edge schemes, improving the end-user voice signal-to-noise ratio (SNR), improves the listening experience for users of existing TDMA (time division multiple access) based networks, by improving the received speech quality by employing background noise reduction or cancellation.

Significantly, in an on-going cellular telephone call or other communication from an environment having relatively higher environmental noise, it is sometimes difficult for the party at the other end of the connection to hear what the party in the noisy environment is saying. That is, the ambient or environmental noise in the environment often “drowns out” the cellular telephone user's voice, whereby the other party cannot hear what is being said or even if they can hear it with sufficient volume the voice or speech is not understandable. This problem may even exist in spite of the conversation using a high data rate (for example, “Rate 1” (9.6 kbps) on the communications network. Therefore, even where an appropriate data code rate is selected by the system and/or device, degradation of the speech may still occur so that it may be bothersome for the listener to maintain or understand the conversation. Poor voice quality is one of the principle reasons for subscriber dissatisfaction.

Attempts to solve the noise problem have largely been unsuccessful. Both single microphone and two microphone approaches at reducing ambient noise have been attempted. For example, U.S. Pat. No. 6,415,034 (the “Hietanen patent”) describes the use of a second background noise microphone located within an earphone unit or behind an ear capsule. Digital signal processing is used in an attempt to create a noise canceling signal which enters the speech microphone. Unfortunately, the effectiveness of the method disclosed in the Hietanen patent is compromised by acoustical leakage, that is where ambient or environmental noise leaks past or is otherwise coupled from the ear capsule and into the speech microphone. The Hietanen patent also relies upon complex, power consuming, and expensive digital circuitry that may generally not be suitable for small portable battery powered devices such as pocketable cellular telephones. Another example, U.S. Pat. No. 5,969,838 (the “Paritsky patent”) discloses a noise reduction system utilizing two fiber optic microphones that are placed side-by-side next to one another. Unfortunately, the Paritsky patent discloses a system using light guides and other relatively expensive and/or fragile components not suitable for the rigors of cell phones and other mobile devices, and/or having costs and or size that make them unsuitable for small hand-held devices. Furthermore, neither Paritsky nor Hietanen appreciate the impact of noise on network capacity or address the need to increase capacity in cellular telephone-based communication systems.

Therefore, there is a need in the art for a system, device, and method of noise reduction or noise cancellation that is robust, suitable for mobile use, has low power or energy consumption, and is inexpensive to manufacture.

There also remains a need for system, device, and method to increase signal to noise ratios in communication devices, particularly with the increased traffic in cellular telephone based communication systems and greater subscriber customer expectations of call clarity and quality.

There also remains a need for a communication system and method of communicating, particularly for a cellular communications network, that permits increased call volume and network capacity without significant additions or alternations to existing network infrastructure, and without compromising the quality and clarity of the communications between parties.

### SUMMARY

The present invention overcomes the problems and limitations of the prior art by identifying communications devices, such as cellular telephones, that are able to operate at a lower absolute or average data rate and data volume than other communications devices so that the communications network on which they operate may take the lower data rate and data volume into account when determining network capacity and communications or call volume. Preferably, the quality of the communication, such as may be determined by objective signal quality standards or the perceived quality of spoken voice at the receiver are as good as higher data rate and higher data volume communications. Communications devices that are limited or forced to operate at a lower data rate than conventional devices may also be employed and achieve the network benefits of lower data volume, increase caller capacity, and the resulting increase in communications network capacity.

In one embodiment, the lower data rate and data volume are achieved by using a low-noise communications device, such as for example a low-noise cellular telephone. Embodiments of such low-noise devices that utilize noise reduction and/or cancellation techniques, including for example but not limited to communications devices that use acoustic wave based background noise cancellation and single and dual microphone based microphone systems that electronically reduce and/or cancel background noise relative to spoken voice may be used. Advantageously, background noise is reduced and/or suppressed relative to spoken voice and a higher voice signal to background noise signal to noise ration is achieved before the spoken voice signal is received by the base-band processor or voice coder in order to achieve the beneficial results. The channel capacity is increased by permitting the desired voice signal to be transmitted without the background noise components which results in not only lower data bit rate signaling opportunities but also lower total and average data volume and fewer data rate switching events.

A database may also be used in the network to track the use of the low data rate communications devices, such as cellular telephone based noise reducing and canceling microphones. As more low data rate devices are used in a network, the disclosed database communicates with the network, and allows a greater number of calls on the network because of the data rate and lower bandwidth requirements of such calls relative to calls not using the low data rate devices such as devices having noise canceling microphones.

The use of noise reduction cellular telephone or other handsets allows for a lower rate of switching in the network. A half rate of switching allows for more users on a network than a full rate of switching. A quarter rate of switching allows for more user capacity than when a half rate of switching is in effect. Less switching from one rate to another rate increases the capacity of a network.

In one aspect the invention provides a method of increasing the volume of calls in a wireless cellular network comprising; detecting the use of noise reduction devices; recording in a database the use of each noise reduction device; and adjusting the number of allowed users of the network in response to the number of noise reduction devices in use.

In another aspect the invention provides an apparatus for adjusting the volume of calls on a network comprising: a database to record the number of users using noise reduction devices; and means for adjusting the number of users on the network in response to the number of users using noise reduction devices.

In yet another aspect the invention provides a method of increasing the capacity of a network comprising: recording the number of noise reducing devices on the network; and adjusting the number of allowed users on the network.

In still another aspect the invention provides an apparatus for adjusting the volume of calls on a communication network comprising: a database to record the number of users using a particular noise reduction device; and a controller for modifying the number of callers permitted on the network in response to the number of callers using the particular noise reduction device.

In still another aspect the invention provides a method of increasing the number of separate communications in a communications network, the method comprising; predicting the use of a low data rate communications device on the communications network; recording in a database the identity of the low data rate communications device; and adjusting the number of allowed users on the communications network in response to the number of low data rate devices.

In still another aspect the invention provides a database coupled to a communications network, the database comprising: a storage device storing an identifier associated with a physical communication device and a data-rate indicator that indicates at least that the physical communication device associated with the identifier is capable of low data rate communications; and the storage device coupled with the communications network or with a management network access system for determining the number of communications devices identified as having low data rate communications capability.

These and other aspects of the present invention will become apparent upon reading the following detailed description in conjunction with the associated drawings.

### BRIEF DESCRIPTION OF THE DRAWINGS

FIG. 1 is a front view of an exemplary telephone and microphone system constructed in accordance with an embodiment of the disclosed invention.

FIG. 2 is a side view of an exemplary telephone constructed in accordance with an embodiment of the disclosed invention with two microphones on the side of the phone.

FIG. 3 is a side view of an exemplary telephone constructed in accordance with an embodiment of the disclosed invention with the voice microphone on the front of the phone and the background microphone on the back of the phone.

FIG. 4 is an illustration showing a block diagram of first embodiment of a noise reduction and/or cancellation processor in which a continuous time computer circuit or discrete time signal processing circuit or continuous time or discrete time technique connected to or utilized with the speech microphone and background microphone according to an embodiment of the invention.

FIG. 5 is an illustration showing a block diagram of an embodiment of a second embodiment of a noise reduction and/or cancellation processor in which a phase processing unit is used to process the background noise signal and in this particular embodiment of a constant or dynamic phase inverter that may provide a phase inverter processing up to 180 degrees and connected to the background noise signal.

FIG. 6 is a block diagram showing internal features of an exemplary mobile or cellular telephone and the relationship between a low-noise microphone input and the Analog base-band/voice coder and the digital signal processor (DSP) and microprocessor elements.

FIG. 7 is an illustration showing the manner in which increased capacity of a communications channel may be increased as a function of increased voice to background SNR.

FIG. 8 is an illustration showing the increase of call capacity as switching rates are reduced.

FIG. 9 is an illustration showing a block diagram of the disclosed database and optional processor coupled with a communications network system that may store and use telephone noise reduction and/or cancellation data in planning and/or operating the communications network.

FIG. 10 is an illustration showing a graph of network capacity increase versus bit rate improvement for an exemplary CDMA cellular system.

### DETAILED DESCRIPTION OF EMBODIMENTS OF THE INVENTION

The present invention overcomes the problems and limitations of the prior art by identifying communications devices, such as cellular telephones, that are able to operate at a lower absolute or average data rate and data volume than other communications devices so that the communications network on which they operate may take the lower data rate and data volume into account when determining network capacity and communications or call volume. Preferably, the quality of the communication, such as may be determined by objective signal quality standards or the perceived quality of spoken voice at the receiver, are as good as higher data rate and higher data volume communications. Communications devices that are limited or forced to operate at a lower data rate than conventional devices may also be employed and achieve the network benefits of lower data volume, increase caller capacity, and the resulting increase in communications network capacity.

In one embodiment, the lower data rate and data volume are achieved by using a low-noise communications device, such as for example a low-noise cellular telephone. Embodiments of such low-noise devices that utilize noise reduction and/or cancellation techniques, including for example but not limited to communications devices that use acoustic wave based background noise cancellation and single and dual microphone based microphone systems that electronically reduce and/or cancel background noise relative to spoken voice may be used. Advantageously, background noise is reduced and/or suppressed relative to spoken voice and a higher voice signal to background noise signal to noise ration is achieved before the spoken voice signal is received by the base-band processor or voice coder in order to achieve the beneficial results. The channel capacity is increased by permitting the desired voice signal to be transmitted without the background noise components which results in not only lower data bit rate signaling opportunities but also lower total and average data volume and fewer data rate switching events.

Embodiments of the invention are now described with reference to the figures. In one aspect the invention provides a device that may be used with a communications device such as a cellular telephone for reducing or canceling ambient background noise from a noisy speech signal such as may be detected when the user of a cellular telephone is speaking in a noisy room, airport, automobile, or other environment having some background noise. In another aspect, the device generates a noise reduced or cancelled signal. Devices having the inventive noise reduction and/or cancellation features are referred to herein as low-noise devices, or in the case of cellular telephones as low-noise cellular telephones.

Recall that the ambient background or environmental noise not only degrades the quality of a call or other voice communication and decreases the speech signal to background noise ratio, but also increases the required data rate per telephone and total data volume in some networks, and reduces the maximum number of calls that can be supported on the network at any give time and the total network capacity for a given network physical and geographical infrastructure.

The present invention provides system, device, and method for reducing and in many instances effectively canceling background, environment, and ambient noise that is present in the caller's (speaker's) environment during the period of the call during both speaking and non-speaking portions of a conversation. The present invention is applicable to the transmission from one or both speakers in a two way conversation so that for example, if only one of the speakers has a device that supports the inventive features and/or is on a network that supports the inventive feature, then that speaker's speech and non-speech periods and his/her network will primarily benefit from the enhancements. In a situation where both speakers have devices and networks that support the inventive features, then both transmissions will benefit.

While the invention is applicable to various communication devices, systems, and networks, including for example the various known cellular and mobile communications devices, systems, and networks, the description presented here by way of example but not limitation is focused on a code division cellular network so that the invention may be described with a sufficient degree of specificity without obscuring the invention.

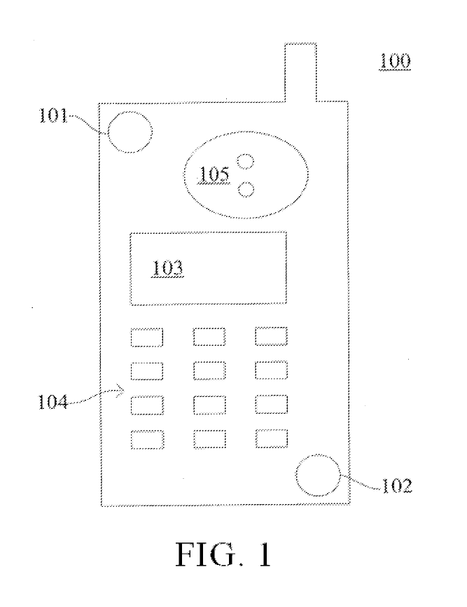

With reference to FIG. 1, the communications device 100 that incorporates the inventive low-noise and low data rate features may for example be a cell phone, cellular telephone, radio phone, satellite telephone, or other communication device, including for example but not limited to devices that include a cell phone or communication device component. In the embodiment illustrated in FIG. 1, the telephone 100 has voice microphone subsystem such as any of the noise reduction or cancellation microphones described elsewhere in this application or in one of the afore identified related applications that are incorporated by reference. Where, by way of example, but not limitation, the microphone subsystem is one that provides either first and second microphones 101, 102 either in the form of separate microphones or apertures and tubes that provide for acoustic background noise cancellation, microphone 102 on the front face or side of the cellular phone and a background microphone 101 also exposed on the front side surface of the cell phone. For reference, the cellular phone 100 of this embodiment may have a display 103, a keypad 104, and ear speaker 105 as are typical of cellular telephones, but they are not required for operation of the invention.

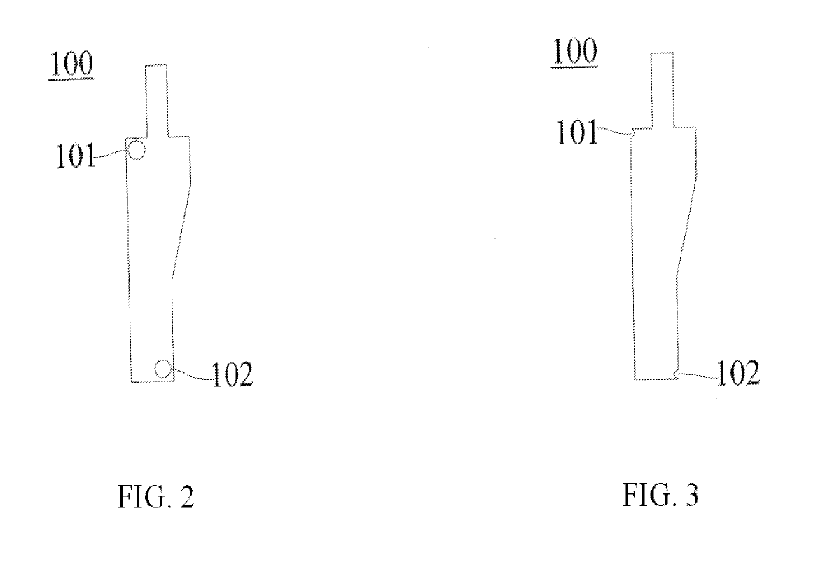

FIG. 2 shows one of the many alternative cellular telephone embodiments having alternative microphone or microphone aperture placements with a side view of a typical communication device 100 wherein the voice signal microphone 102 and background signal microphone 101 are located on the side of the phone.

FIG. 3 shows a side profile view of one of the many alternative embodiments with a voice signal microphone 102 on the front of the phone 100 and a background microphone 101 placed on the back side of the phone. It will be apparent to those workers having ordinary skill in the art in light of the description provided herein that the invention is not limited to any particular microphone placements on the phone or other communications device 100, but that the voice microphone should advantageously be placed where it can collect or detect the speech of the user with sufficient amplitude and clarity, and that the background or ambient sound microphone should advantageously be placed at a location where it can collect or detect the background or ambient sound that is desired to be reduced or cancelled and preferably not collect or detect a high amplitude component of the speech signal.

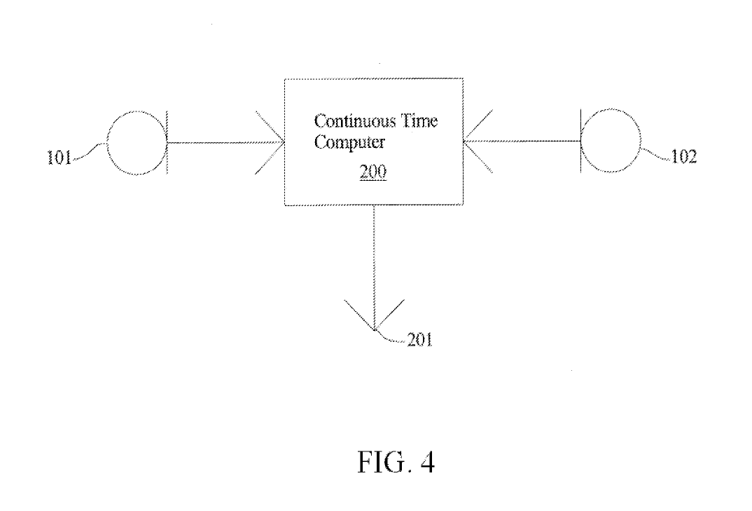

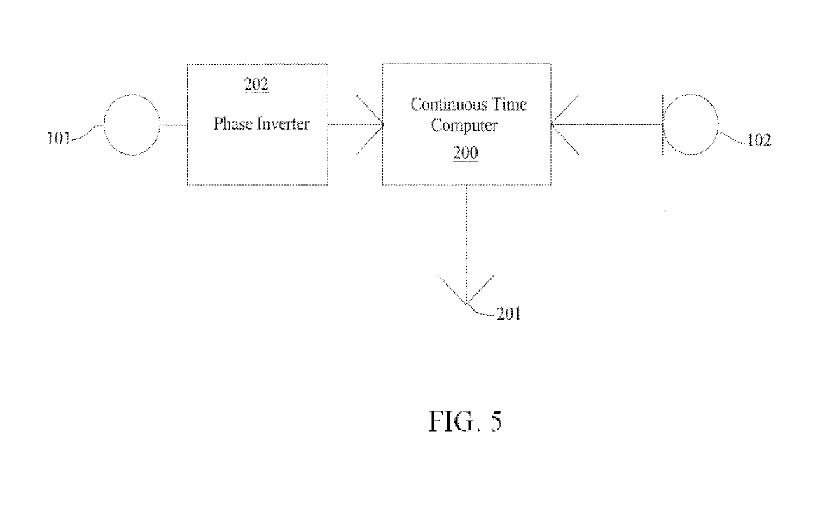

FIG. 4 is a block diagram of an exemplary embodiment in which a background microphone 101 signal and a and voice signal microphone 102 signal enter the Continuous Time Computer circuit 200 or discrete time signal processing circuit or otherwise utilize continuous time (e.g., analog) or discrete time (e.g., digital) techniques. It may be appreciated in light of the description provide herein that references to discrete time signal processing techniques may include any one or any combination of, but are not limited to, the following techniques: LMS filtering, RLS filtering, Kalman filtering, extended Kalman filtering, spectral processing and/or filtering, spectral subtraction, spectrum substruct, and the like. The Continuous Time Computer Circuit (or discrete time signal processing output) creates an output at 201 or discrete time signal processing techniques wherein the background input of 101 is removed from the voice signal input of 102. In alternative embodiments, a combination of the continuous time and discrete time processing circuits and/or techniques may be utilized to generate a noise reduced output from the primarily background noise input signal 101 and the primarily voice signal 102 but having a noise component. In yet another alternative embodiment, described in the related applications, the continuous time processing (computer) comprises an acoustic wave interference system that utilized physical wave interference to achieve a reduced noise component at the microphone. The microphone then directly generates a noise reduced or cancelled signal 201 that is applied to the analog baseband and/or voiceband codec of the telephone.

These noise reduction or cancellation communications devices are one class of low data rate devices that may advantageously per part of or used in conjunction with the database for increasing the capacity of a communications device.

FIG. 5 is an illustration showing the noise reduction and/or cancellation microphone system according to one embodiment of the invention providing an input to the analog base-band/voiceband codec of an exemplary cellular telephone.

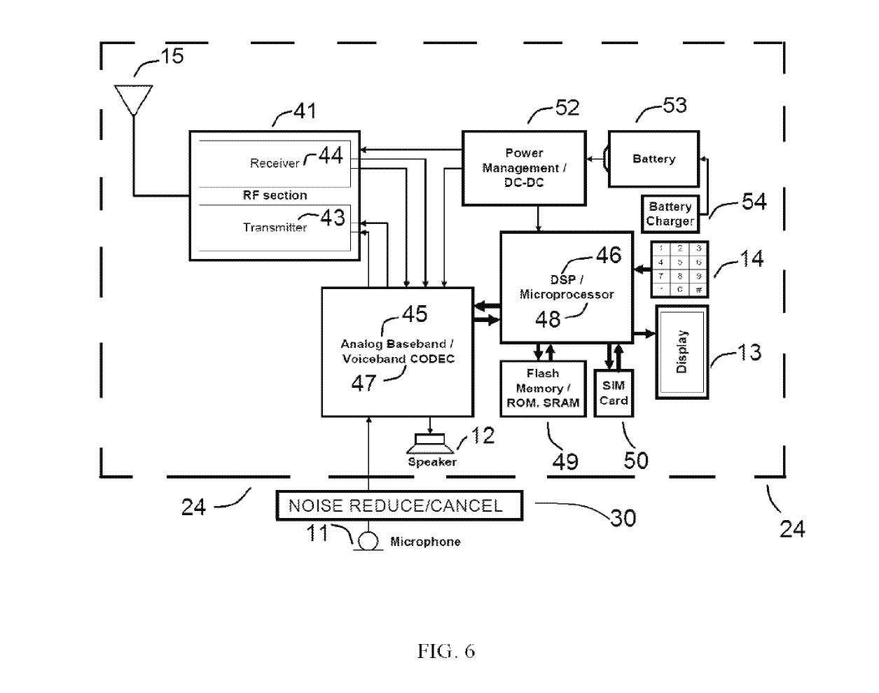

FIG. 6 is an illustration showing a block diagram showing internal features of an exemplary mobile or cellular telephone and the relationship between a noise reduction and/or cancellation processor 30 used in conjunction with one or a plurality of microphones to provide a noise reduced or cancelled signal input replacing standard microphone input(s). The noise reduced and/or cancelled analog voice input is received as an input by the analog base-band/voice coder and the digital signal processor (DSP) and microprocessor elements.

It will be appreciated that the processing occurs outside of the conventional cellular telephone equipment and therefore augments and works synergistically with the noise reduction circuits, processing, and/or techniques that may be applied therein. For example, by providing a voice signal with less absolute background noise levels or higher voice to noise SNR, the AMR, DTX, and other processing that may occur within the cellular, mobile, or other radio-based communications device, the performance may be maintained or improved in spite of reduce data rates, frequency of rate switching, and the like.

Aspects of the conventional cellular telephone, such as a GSM cellular telephone are now described so that the relationship of these elements with the inventive elements may be more clearly understood.

Having now described aspects of embodiments of the inventive noise reduction and cancellation processing systems 200 (continuous time computer with or without the phase processor or inverter 202) in FIG. 4 and FIG. 5 and shown here in FIG. 6 as generalized processing block 30 relative to a microphone and the other components of the communications device such as a cellular telephone, we now describe the relationship of these processing blocks relative to a conventional cellular telephone architecture to illustrate the relationship between the inventive processing block and the analog baseband/voiceband codec or other stage of a communications device that normally receives the electrical signal output by the microphone. While this embodiment shows only a single microphone 11 embodiment, it will be appreciated that two-microphone embodiments may be used to generate a noise reduced or cancelled signal to the analog baseband 45 or voiceband codec 47 of the telephone. Furthermore, any other circuit, physical device, or method may be used to reduce the noise input to the cellular telephone, including for example acoustical wave cancellation processing and that the invention is not limited to any particular structure or method.

FIG. 6 illustrates a block diagram typical of the major functional blocks of a cellular telephone of the type not having the noise reduction and cancellation processing of the invention. This architecture is described so that the manner in which the invention interoperates with and improves the performance may be better understood.

Radio Frequency or RF section 41 includes a transmit section 42 and a receive section 43 and is where the RF signal is filtered and down-converted to analog baseband signals for the receive signal. It is also where analog baseband signals are filtered and then up-converted and amplified to RF for the transmit signal. Analog Baseband 45 is where analog baseband signals from RF receiver section 44 are filtered, sampled, and digitized before being fed to the Digital Signal Processing (DSP) section 46. It is also where coded speech digital information from the DSP section are sampled and converted to analog baseband signals which are then fed to the RF transmitter section 43. It will be understood that no radio-frequency (RF) section or antenna would be required for a wired line implementation.

The Voiceband Codec (VoCoder) 47 is where voice speech from the microphone 11 is digitized and coded to a certain bit rate (for example, 13 kbps for GSM) using the appropriate coding scheme (balance between perceived quality of the compressed speech and the overall cellular system capacity and cost). It is also where the received voice call binary information are decoded and converted in the speaker or speakerphone 48.

The digital signal processor (DSP) 46 is a highly customized processor designed to perform signal-manipulation calculations at high speed. The microprocessor 48 handles all of the housekeeping chores for the keyboard and display, deals with command and control signaling with the base station and also coordinates the rest of the functions on the board.

The ROM, SRAM, and Flash memory chips 49 provide storage for the phone's operating system and customizable features, such as the phone directory. The SIM card 50 belongs to this category, it stores the subscriber's identification number and other network information.

Power Management/DC-DC converter section 52 regulates from the battery 53 all the voltages required to the different phone sections. Battery charger 54 is responsible for charging the battery and maintaining it in a charged state.

Keypad 55 and display 13 provide an interface between a user and the internal components and operational features of the telephone.

It will be apparent to those workers skilled in the art that the inventive noise reduction and cancellation block is interposed or coupled between the microphone 11 (single, or plural) of the telephone in its conventional configuration and the analog baseband/voiceband codec of the conventional telephone. In fact the output of the noise reduction processing block 30 may be seen to be a processed version of the original microphone input and may connect at the same microphone input port as in a conventional phone. Not shown in the drawing is a possible connection between the noise reduction processing block 30 and the battery 53 (or the power management block 52 (depending upon implementation) that might be needed for a cellular telephone, but may not generally be needed for a wire lined device. The noise reduction processing block 30 may optionally rely on a separate power source such as an auxiliary battery that only powers the noise reduction processing block 30. It will also be appreciated that a wire lined device may not require a battery or battery charger and would receive electrical power (voltage and current) from other electrical supply sources within the device.

An alternative embodiment of the inventive noise reduction processing block 30, may use first and second microphones and the remainder of the exemplary cellular telephone 40. Again, it will be apparent to those workers skilled in the art that the inventive noise reduction and cancellation block is interposed or coupled between the first and second microphones of the telephone and the analog baseband/voiceband codec of the conventional telephone. It will be apparent in this embodiment that even though there are two microphones, there is still only one noise reduced signal output from the noise reduction and cancellation processor to the input of the analog baseband/voiceband CODEC so that no modification of the cellular telephone input circuitry is required. Again, the output of the noise reduction processing block may be seen to be a processed version of the original dual microphone input and may connect at the same microphone input port as in a conventional telephone.

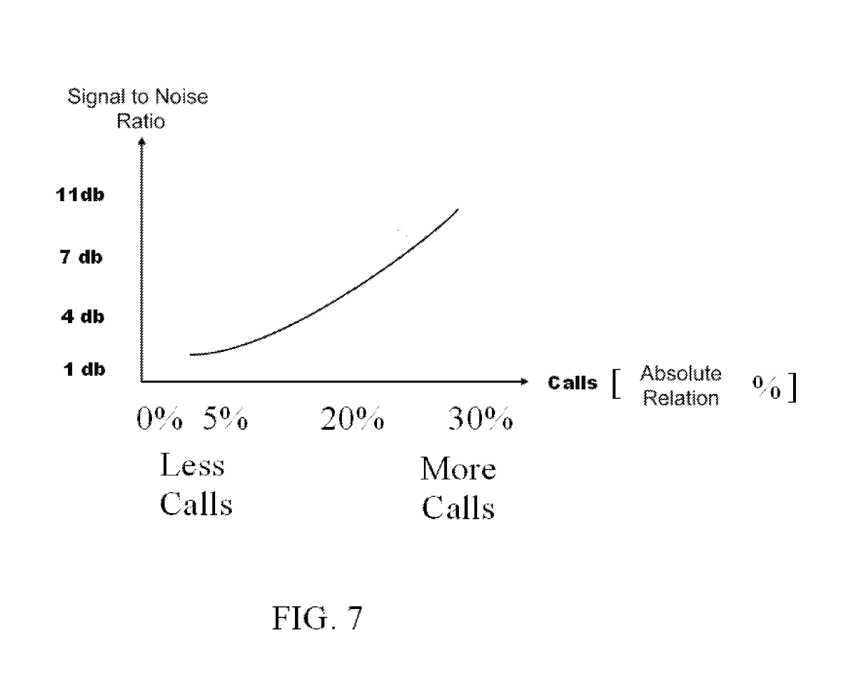

FIG. 7 is an illustration showing a graph of the relationship between increasing SNR on the horizontal x axis and increasing signal channel capacity on the vertical y axis. As the signal to noise ratio (and correspondingly the carrier to interference ration (C/I) increase, the channel capacity increases. For each noise reduced and/or noise cancellation cellular telephone used on a channel, the channel capacity is incrementally increased, and when many cellular telephones are used on the network channel in this way the channel capacity and therefore the network capacity may be increased substantially as compared to conventional cellular or mobile telephones.

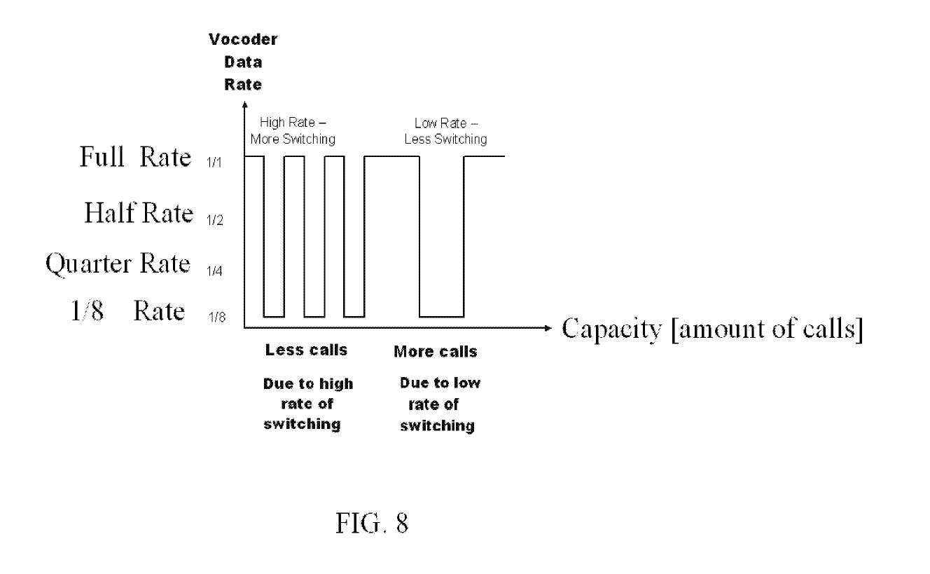

FIG. 8 is a diagrammatic illustration showing the relationship between decreasing the rate of switching on the vertical y-axis and increasing network capacity for calls on the horizontal x-axis. When there is a higher switching frequency, that is more rate switching between a higher rate (such as full rate) and a lower rate (such as half rate) fewer calls may be supported on a communications channel and by the network. Correspondingly, when their is a low switching rate, more calls may be supported by a communications channel and network due to that lower rate of switching. The inventive system, device, and method provides lower vocoder switching rates during both speech intervals and non-speech intervals and therefore increases channel and network capacity for the same infrastructure.

Recall that in the code division cellular network, the voice code data rate is determined by an algorithm which designed to select “Rate 1” or full data rate (9.6 kbps) for speech and “Rate ⅛” or one-eighth data rate (1.2 kbps) for non-speech portions of the communication; where non-speech portions of the communications on each potential speaker's side might include for example, periods of time where the user at that end is listening and not speaking.

The “Rate 1” data code rate would normally provide the highest fidelity speech, whereas the “Rate ⅛” may not provide adequate fidelity to understand the speaker. Other rates such as “Rate ½” (4,8 kbps) or “Rate ¼” (2.4 kbps) present similar compromises such that generally, it is best to use the lowest possible data rate for a non-speech portion of the communication and the highest or at least a relatively high data code rate for speech portions. In some instances, a “Rate ½” transmission may be acceptable, and even a reduction in non-speech portions of the conversation at the “Rate ¼” data code rate may be acceptable. Speaking and non-speaking portions may occur at one or both ends of a normal conversation.

Recall further, that background, ambient, or environmental noise not relevant to the conversation are often misinterpreted by the rate determination algorithm within the system and/or cellular handset as voice, so that a higher rate than required (such as for example the 9.6 kbps “Rate 1” mode appropriate for speech is used for the non-speech portion rather the lower 1.2 kbps “Rate ⅛” intended to be used for non-speech portions, and that use of a higher data code rate than required and the unnecessary switching between data code rates both result in consuming unnecessary network bandwidth and decreasing network capacity. Even where the lower data rate is used for portions of the non-speech portions, certain types of noise that enter the cellular telephone handset microphone may also causes the rate to be switched to back-and-forth between higher and lower rates that result in decreased network capacity and supportable call volume.

The present invention provides for improved noise suppression and in many cases substantially complete cancellation of ambient, environment, or background noise that is both present during speech and non-speech portions of the conversation and but for the invention described herein would result in a higher than required non-speech data code rate, unnecessary rate switching during non-speech periods, and degradation of the speech signal even where optimal or near optimal data code rates are selected.

Embodiments of the invention reduce or cancel the noise that would otherwise enter the base-band processor and/or voiceband codec functional blocks, and where present the discontinuous transmission (DTX) mode decision functional block and other data rate determining functional blocks within the cellular transmitter that determines the rate, whether the rate be full rate, half-rate, quarter-rate, eighth-rate, or other rate. By removing the noise before the signal enters the rate determining block, the burden on the block to make the correct rate decision is reduced, so that (i) the rate determining block can more readily identify speech and non-speech periods, (ii) the rate within a speech or non-speech period is more or less stabilized and the switching between rates is minimized while permitting appropriate rate changes that should occur when changing between speech and non-speech, and (iii) to reduce noise so that quality and clarity are improved even when an appropriate speech or non-speech rate is utilized for the transmission.

The noise reduction either alone or preferably in combination with a communications network database that identifies characteristics of the call or communications device connected for the call that results in the above network capacity and call volume increases may be achieved in a variety of ways and the invention is not limited to any particular type of noise reduction. It will be appreciated that the noise reduction and the use of low-noise communications device permits the network call volume and capacity increases to be achieved, however, by providing the network with a database that identifies a low-noise communications device that is or may utilize the network, the network is able to plan for lower data rates by the low-noise devices and allocate additional network resources that are freed up to additional subscribers.

While the inventive network having a database storing a low-noise device identifier may be utilized with communications devices that can consistently operate with lower data rates that a full data rate, the invention may advantageously be utilized in conjunction with any one or combination of noise reduction and cancellation devices, systems, and methods that are described in the following co-pending U.S. patent applications: U.S. patent application Ser. No. 11/402,405 (Attorney Docket No. 60819-8001.US01) filed 11 Apr. 2006 and entitled Method and Apparatus to Improve Voice Quality of Cellular Calls by Noise Reduction Using a Microphone Receiving Noise and Speech from Two Air Pipes; U.S. patent application Ser. No. 11/402,521 (Attorney Docket No. 60819-8002.US01) filed 11 Apr. 2006 and entitled Environmental Noise Reduction and Cancellation for a Voice Over Internet Packets (VOIP)Communication Device; and U.S. patent application Ser. No. 11/402,459 (Attorney Docket No. 60819-8003.US01) filed 11 Apr. 2006 and entitled Environmental Noise Reduction and Cancellation for a Cellular Telephone Communication Device.

Each of these patent applications describes device, system, and method for reducing and potentially entirely canceling ambient, environment, or background noise from the speech signal input before the speech plus noise signal reach the rate determining block in the processor of the cellular telephone or other communications device. Each of the systems, devices, and methods of noise reduction or noise cancellation described in the referenced patent applications provides a noise reduction scheme that is robust, suitable for mobile use, has low power or energy consumption, and is inexpensive to manufacture. Other noise reduction and/or cancellation devices, systems, and/or methods may be used in conjunction with the inventive network and call capacity increasing aspects of the invention to achieve the overall benefits. Furthermore, the inventive database and method of accessing the database to identify other communications devices (including but not limited to cellular telephones) may be used in combination with any other communication device that is able to limit its operation to a lower data rate than other communications devices accessing the network. The lower data rate operation may be achieved all of the time, or may be achieved only a portion of the time so long as the portion of the time is sufficiently large to permit the network to increase its capacity in reliance on the portion. For example, if a conventional cellular telephone communications device operates at full-rate 50% of the time and one-quarter rate at 50% of the time for a given set of operating conditions, and another cellular telephone communications device is operate at half-rate 40% of the time and one-eighth rate 50% of the time, but may occasionally require full-rate operation 10% of the time, then the network will still be able to predictably rely on lower data rates and data volumes over the network from the lower-data rate telephone in proportion to the reduced data volume. Particularly, when large numbers of such lower data rate telephones are operating on the network and identified in the database, the increased network capacity and supportable call volume may be relied upon. In one embodiment, usage information such as subscriber plan, day of week, time of day, information or factors may be used. Subscriber plans may optionally also be tailored to incentive certain users not to use their telephones during peak network access periods.

For example, in at least one embodiment of the dual microphone implementation described in U.S. application Ser. No. 11/402,459 the average forward-link data rate generated by the voice coder (vocoder) is reduced by about thirty-percent (30%) to thirty-five percent (35%) in noisy conditions. Other of the embodiments provide for similar reductions in the forward-link data rate generated by the voice coder. The reduced forward-link data rate results in less data being passed through the network and so a 30% to 35% decrease in forward-link data rate results in about a corresponding percent increase in network capacity and call volume that is available for other subscriber calls and new subscribers without any decrease in call quality or voice clarity.

The noise reduction and/or cancellation that can be achieved using one of the noise reduction and/or cancellation techniques described elsewhere in this application and/or in the incorporated by reference related patent applications provides voice quality and clarity even where an appropriate data code rate is selected by the system and/or device. Furthermore, for the time based schemes, like GSM or GPRS or Edge schemes, the improvement in the end-user voice signal-to-noise ratio (SNR) that results from background noise reduction or cancellation, improves the listening experience for users of existing TDMA (time division multiple access) based networks.

Additional aspects and features of embodiments of the invention are now described so that the manner in which the network capacity and caller capacity volume increases are achieved may be more readily understood.

The voice coder (VoCoder) such as for example the vocoder used in GSM/GPRS/EDGE based systems as well as Wide Band CDMA (WCDMA) is typically an Adaptive Multi Rate (AMR) based vocoder. Adaptive multi-rate vocoders dynamically change data rates depending on any one or more of a number of factors. AMR vocoders may for example operate in any one of a Full Rate mode, a Half Rate mode, a Quarter Rate mode, and/and or an Eighth Rate mode. Modes may alternatively be described more specifically in terms of actual data rates (Kbits/s for example).

The relationship between AMR and carrier-to-interference ration (C/I) may be understood more clearly relative to some numerical examples.

The eight conventional AMR full rate modes operate at the following data bit rates (in Kbits/s): 12.2, 10.2, 7.95, 7.4, 6.7, 5.9, 5.15 and 4.75; and, the six conventional AMR half rate modes operate at the following bit rates: 7.95, 7.4, 6.7, 5.9, 5.15, and 4.75 Kbits/s. Since the gross bit rate in a half-rate channel is only 11.4 Kbits/s, a much small number of bits is available for channel coding, thus requiring a better or higher C/I. But with a better radio signal, AMR can enable half-rate operation, which translates to more users and higher capacity in the same number of cellular telephone radio channels. AMR half-rate mode is further enhanced in EDGE radio networks where more bits per time slots are available.

It may also be appreciated that the benefits of AMR do not depend on all mobile or cellular tells phones implementing AMR. As the percentage of mobile or cellular telephones with AMR increases in the network, the efficiency of the network increases. For instance, with about 50% of mobile or cellular telephones using AMR, voice capacity can increase by about 50%, whereas with 100% AMR cellular telephone usage, voice capacity can increase by a full 150%, that is at more than a linear rate of increase in capacity.

The gross bit rate of the channel (1 time slot) is 22.8 Kbit/s, which is divided into voice information and error control. As an example, operation in a 7.95 Kbit/s mode means that more than half of the bit rate (approximately 22.8 Kbit/s-7.95 Kbit/s minus some overhead) can be allocated to channel coding (forward error correction). By decreasing the AMR rate, resistance to errors increases further.

It will be appreciated that there may typically be a trade-off between voice coding and error control. There may also be an effect on voice quality (Mean Opinion Score) versus the Carrier-to-Interference (C/I) ratio. Aspects of the invention provide improved or at least maintain voice quality while still reaping the advantages of lower bit rate communication.

Best call quality and call holding times are typically achieved by operating these systems using the Full Rate mode but operation in this Full Rate mode results in greater data volume which has the effect of reducing the number or possible concurrent calls on the network. These impacts may not be of any significant consequence when the network is sized for a greater capacity than the maximum capacity required for Full Rate mode, but advantageously the network operator would prefer to increase the capacity of the network without increasing the network infrastructure.

Although AMR vocoders may perform reasonably well under optimal network conditions, with the high carrier-to-interference (C/I) ratio a ratio of about 10 db may be considered “good” though not optimum while a ratio of about 5 db is considered “poor”) associated with such optimal network conditions, the performance of Half Rate vocoders quickly deteriorates in low C/I ratio conditions, especially when ambient or environmental background noise is present. As a result, Half Rate vocoder calls result in reduced call holding time, that is the period of time during which the call is held without dropping or being lost. The user or customer satisfaction deteriorate as well, and the network operators or carriers prefer to operate in a Full Rate mode regime and are reluctant to enable Half Rate (or even other lower rates) in the network. Operation at the higher rates, particularly at full rate, consumes a large amount of the total capacity of the network and reduces the volume of calls and ultimately the number of subscribers that can be supported by a given physical infrastructure.

Removing ambient background noise impairments and improving the quality of Half Rate calls to a voice quality level equivalent or substantially equivalent to Full Rate calls is an and innovative intelligent enhancement for Half Rate vocoders, and increases the volume of calls that can be supported over an existing infrastructure, and consequently increases revenue and profit potential for the network provider or carrier.

Furthermore, by extending the geographic area where calls with acceptable voice quality can be made, the network capacity is enhanced as well as volume of supported calls, without requiring location of additional cell base stations. It is also effective at cell-edges (the regions near the edges or limits of a cells coverage) with low C/I ratio.

GSM/GPRS systems are presently using or at least supporting a discontinuous transmission (DTX) mode. It allows system or the Base Station Subsystem (BSS) to disable transmission during periods of voice inactivity, such as during periods where the device or system determines where there is no speech. So called “comfort noise” may be injected and sent so that there is a sense of connection with the other party in the conversation rather than the complete silence that may suggest a dropped call or lost connection.

The use of discontinuous transmission (DTX) mode which is facilitated by having a relatively noise free microphone or processed microphone input to the baseband processor can significantly reduce improve network capacity and performance. For example, a capacity increase of at least up to about 30 percent, but not limited to that, is possible when Downlink DTX is turned on in a random frequency hopping GSM network using power control. Power control is a technique wherein at least for GSM systems as specified in GSM TS 45.005 Radio Transmission and Reception (incorporated herein by reference), control of nominal output power is done in 2-dB steps. The maximum output levels for handset mobile station class 4 GSM is +33 dBm (for 850/900 MHz) and for class 1 DCS and PCS is +30 dBm (for 1800/1900 MHz). The dynamic range of power control is specified at 28 dB for the 850/900 MHz band and 30 dB for the 1800/1900 MHz band. Power control is advantageous in these systems to prevent intermodulation in base station receivers, to prevent interference with other mobile phones, and to minimize power consumption in the mobile phone. Advantageously, the minimum power necessary for reliable communication should be used with the selected base station, and may usually depend on distance between the handset transmitter and the base station.

When the background noise reduced, the voice activity circuitry in the system and/or cellular handset can more effectively distinguish between incoming speech and noise. When the noise can be more accurately distinguished, the speech will not cut in and out so that clarity of the speech is maintained, and transmission will effectively be suspended during periods of time when there is only noise detected and no speech. This accuracy in determination results more frequent or effective DTX usage, and results in an increases the capacity of the network and the amount or number of calls capable of being supported in the network for a give network infrastructure.

Embodiments of the present invention remove ambient impairments, such as for example ambient or background noise prior to the DTX block, so that the DTX determination can be made more accurately and the benefits of the DTX mode realized more efficiently. The reduction or cancellation of noise also improves the quality of half rate calls or transmission to a voice quality level close to the equivalent of full rate calls or transmissions.

By extending the geographic area where calls with acceptable voice quality can be made, the disclosed invention is particularly effective at cell-edges with low signal level conditions. Therefore it will be appreciated that noise reduction and/or cancellation benefits data rate reduction, DTX block operation, and performance near or at cell edges and therefore contributes to the increased network capacity and volume of calls that may be supported on a given infrastructure.

In light of the description provided herein, it will now be appreciated that the existence of noise is the or at least one of the most limiting factors to the volume of calls or capacity of a communications network. With further reference to FIG. 7, it may be observed that reduction or cancellation of background noise improves the signal-to-noise ratio, decreases the switching between full rate to half rate, and between half rate and quarter rate, and between quarter rate and one eighth rate, and increases the number of calls that a given network can support.

Recall that the present invention is directed toward the design and construction of communications systems and methods that provide a database for storing and retrieving information about the data rate capabilities of a communications device. The invention may also provide analysis means for analyzing the communications network in light of the number of low data rate and normal data rate communications devices that are currently using and transmitting voice on the system, or for predicting in a deterministic, numerical, or statistical sense how to size the communications system to support the predicted number of communications, data volume, cellular telephone calls or transmissions, and the like,

Lower data rate communications devices, such as cellular telephones or other communications devices that provide or utilize a microphone or signal input system that yields an increased signal-to-noise ratio (SNR) to other components of the communication device or cellular telephone handset provide capacity advantages as described. In one embodiment the increases signal to noise input signal is an input to the baseband processor so that the noise reduction or cancellation is achieved prior to such functional blocks as the vocoder, rate determining block, DTX decision block, and/or other elements that benefit from either lower absolute noise and/or a higher voice or speech signal-to-noise ratio.

Different embodiments of the invention may utilize alternative microphone or transducer input means for reducing noise and increasing the speech signal-to-noise ratio. In co-pending U.S. application Ser. No. 11/402,405 (Attorney Docket No. 60819-8001.US01) filed 11 Apr. 2006 and entitled Method and Apparatus to Improve Voice Quality of Cellular Calls by Noise Reduction Using a Microphone Receiving Noise and Speech from Two Air Pipes, microphone assembly having a single microphone transducer for converting an incident sound acoustic wave to and electrical signal representation of the wave is provided. Two acoustic pipes, channels, tubes, or other acoustic sound wave communicating means couple or conduct a first primarily speech acoustic signal that is contaminated by background noise, and another second signal that is primarily background noise (and probably also includes a speech signal component that is lower amplitude or power than the first primarily speech acoustic signal). These two acoustic signals are physically brought together in a manner that the second background acoustic sound wave is used to cancel the background noise acoustic wave that contaminates the speech signal by physical wave destructive interference in a volume of air or other media at or adjacent to the microphone transducer. The microphone transducer, such as a diaphragm that moves or vibrates in response to the incident resultant sound waves, senses the resultant waves and generates a signal that is primarily the speech signal with the background noise reduced or cancelled.

In co-pending U.S. Application No. 111/402,459 (Attorney Docket No. 60819-8003.US01) filed 11 Apr. 2006 and entitled Environmental Noise Reduction and Cancellation for a Cellular Telephone Communication Device; each of which patent application is hereby incorporated by reference, a signal processing approach is taken to reduce and/or cancel ambient or environmental background noise, using either a single microphone, or a plurality of microphones.

In a two microphone embodiment, a background microphone captures ambient sound or noise which is removed in a continuous time subtraction technique from the sound captured from a voice or speech signal microphone or by discrete time signal processing techniques. (Note that in general the background microphone captures primarily background or ambient sound but also some voice or spoken sound, and that the voice signal microphone captures primarily voice but may also capture some background or ambient sound.)

The electrical signals from the two microphone inputs are processed using either one of a combination of continuous time processing and discrete time processing and the result of the processing circuitry is a new equivalent microphone output that has an increased SNR for the voice signal as compared to the typical single microphone system without the processing. The output from the processing circuitry is applied as an input to the baseband processor of the conventional communications device in place of the conventional single microphone output signal.

In the conventional single microphone system not including either the acoustically based continuous time processing (e.g., physical wave interference) or the single or multiple microphone combined with continuous time and/or discrete time processing, both unwanted background noise and the desired voice single enter the communication system. In the present invention, the background noise that would otherwise enter the communications device as a microphone input component entering the conventional single microphone is removed by subtracting background noise.

Embodiments of the invention may utilize communication devices having various microphone and signal processing means, possibly including either one or a combination of acoustic signal processing and electronic signal processing.

For example, in one embodiment of this invention, the subtraction of background noise from speech is carried out in a continuous-time or analog based processing circuitry, where the circuitry is low power consumption and appropriate for small portable battery-powered devices. In another embodiment, the subtraction or difference operation that removes or cancels the noise from the noise plus voice signal is carried out using digital circuits, while in yet other embodiments, elements of the subtraction or difference operations are performed by a hybrid combination of continuous time or analog circuits and digital circuits and techniques. Yet other embodiments may utilize a combination of acoustic and electronic processing.

In one embodiment the collection or detection of the background noise signal and the speech voice signal is carried out by analog or continuous time based processing circuitry that is interposed in the processing scheme between the standard single microphone signal input and the conventional audio processing circuitry or logic for conventional cellular phones. Usually this conventional audio processing circuitry or logic will also precede the baseband processing circuitry of logic but in some conventional cellular telephone architectures they may be combined into a single functional block. In these situations at least some embodiments of the invention provide for the noise reduction to occur before both the conventional audio processing and the conventional base band processing.

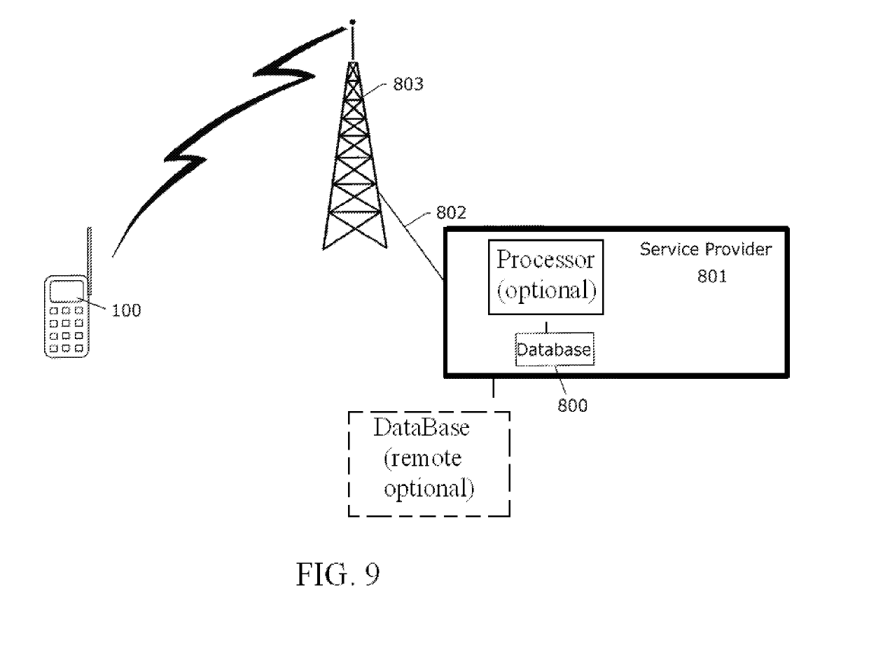

The present invention contemplates any one of a myriad of single or multi-microphone configurations such as the two microphone scheme shown on FIG. 1 and a database 800 of FIG. 9. Aspects of the invention are also usable with any other device that is able to maintain operation at least some of the time, at a lower data rate than other communication devices operating on the network. In fact, though not preferred, if a subscriber is willing to sacrifice some performance or call quality and voice clarity, the subscriber may even choose to communicate with a lower data rate communications device in exchange for some fee discount on the service.

The inventive database 800 provides a means for marking or otherwise identifying that a particular communications device, such as a cellular telephone handset (and the user of the handset), includes a compatible background noise reduction and cancellation subsystem and method (such as the inventive background noise reduction and cancellation technique) that results in the same or equivalent reduction of data volume, reduction in the required bandwidth, and reduction in data rate switching. Such devices provide for an increased speech signal-to-noise ratio at the input of the so that the noise reduction or cancellation is achieved prior to such cellular telephone handset functional blocks as the vocoder, rate determining block, DTX decision block, and/or other elements that benefit from either lower absolute noise and/or a higher voice or speech signal-to-noise ratio. These features and benefits mean that the network may predict (either in an absolute sense or in a statistical sense) that the transmissions from this particular communications device will require of consume fewer network resources than a communications device that does not include these features. The network operator may also continuously, periodically, or on some other timed or random basis, query the database and assess the total network capacity for all communication devices that may be used on the network. An optional processor may be provided to perform deterministic, statistical, or any other processing or analysis, such as may be desired or required. Alternatively, such processing may be performed by the service provider or external entity. Furthermore, although the database may exist at one location, such as for example at a facility owned and/or operated by the service provider, the database may alternatively be remote and at a different location, or be distributed so as to exist either entirely or in parts at multiple locations.

Such analysis may include calls made from communications devices tied to or associated with its own network only, or may also include analysis of calls made into its network by devices outside of its own network. In one embodiment of the invention, at least in part because calls and transmission made into its network may be made from a large and a priori unknown set of communication devices, the analysis for out of network devices (such as for example roaming devices) may generally be made based on a statistical analysis of prior history. In another embodiment, communications device itself may transmit a signal that identifies the communications device as a device that includes some, a combination of, or all of the elements that provide for lower data rates and volume, lower absolute background noise level, higher speech signal-to-noise ratio, better operability with the internal vocoder, better operability with any DTX decision block, and/or even better operability with other device components existing now or that may be developed, and the like that permit the network operator to predict network resource consumption for a give quality of service and clarity of signal.

In one embodiment, the network operator may perform a query operation for each new communications device it encounters and determine its characteristics. These characteristics may then optionally be stored in a database so that the next time the network interacts with the device it will know which if any of the features the device has and will not require the characteristic query. The database may either store an identifier that is unique to a particular physical device which is preferred, or it may store the telephone number associated with the device at the time of the call which is less preferred since telephone numbers are not uniquely associated with a physical device and may change over time as a user moves his/her service among different carriers or replaces the physical device with a different one. In one embodiment of the invention, a date indicator may be stored in the database that is identified with the telephone number, and a procedure may be implement by the network operator that accesses the age of the information and may chose to ignore, discount, or decrease a weight given for the information, if the information is old or falls into some other age category.

In some embodiments of the invention, a plurality of entries or a single entry that has a plurality of entries in the form of binary bits, flags, bytes, or other indicators may be made for each communications device database entry. These plurality of entries may identify particular capabilities and/or features within the device either alone or in combination with interoperable network features. For example, different microphones and/or microphones in combination with continuous time and/or discrete processing may provide different absolute background noise levels and/or different signal-to-noise levels. In some instances it may be beneficial to treat these devices having different characteristics in somewhat different ways. Multiple bits may therefore be used to identify these different characteristics. In other instances, it may be useful to identify different vocoders, DTX detection logic, or the like using different database identifiers so that better prediction as to data transmissions, network capacity, and supportable call volume may be made. Therefore, in some embodiments of the invention rather than a single identifier being used to characterize a communications device to the network, a plurality of identifiers may be used so that additional particular capabilities are identified.

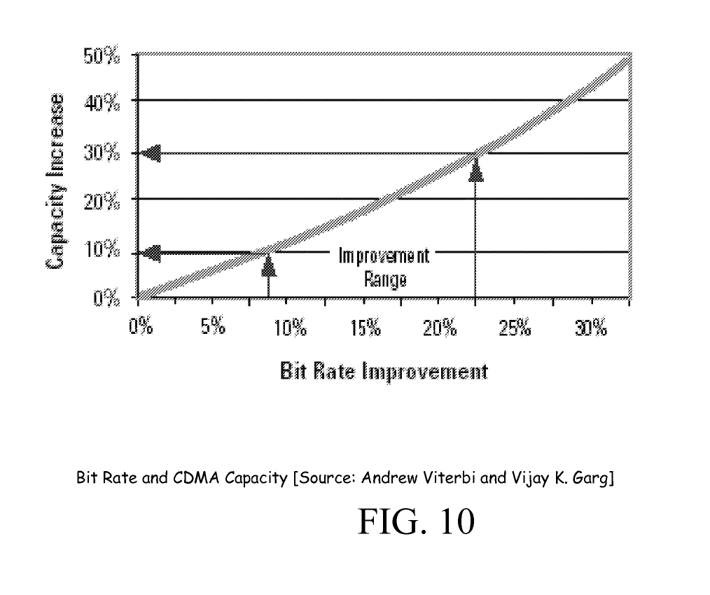

With reference to FIG. 10 which shows a graph of network capacity increase versus bit rate improvement for an exemplary CDMA cellular system. It may be seen that the capacity increases more than linearly with a bit rate improvement, here shown as a percentage improvement on the horizontal axis of the graph. In exemplary tests, where the average bit rate was reduced from 6 kbps to 5 kbps, representing about an 18% bit rate reduction which, about a 22% call volume or network capacity increase is achieved. In real world situations where the deployments of the noise reduction or cancellation communication devices are in noisy conditions, typically improvement of forward-link capacity by is expected to be at least in about the 10% to 25% improvement range.

Having now described features and characteristics of the communications device, such as a cellular telephone, and the database coupled with or accessible by the network or network operator, the stores the communications device information identifying the communications device as being one that can provide at least one of lower absolute noise, higher speech signal-to-noise ration, lower data rate operation, lower network data volume, less frequent data rate switching, and the like, attention is now directed to a further description of the invention in operation.

In one embodiment, when a user purchases or otherwise acquires a communications device (such as for example a cellular telephone or a PDA that includes a cellular telephone capability), and the user registers the device with or becomes a subscriber to a particular network operator or provider (such as for example, Cingular Wireless, T-Mobile, Verizon, or the like) one or more databases under the control of the network operator or provider are updated to identify the device as a low-noise device having one or more of the inventive features described above. In one embodiment, the particular network operator may optionally share the information concerning the device with other network operators or providers. In one embodiment, the identity of the device as a low-noise device is made at the time of manufacture so that the identify of the device as a low-noise device is established by reference to a manufacturers database. In one embodiment, the identity of the device as a low-noise device may be made by querying the device according to a test procedure. Other embodiments may provide for various other procedures for identifying the particular device as a low-noise communications device. When a plurality of information items are provided that further characterize the additional or particular low-noise characteristics of the device, these additional characteristics may also be provided to the database.

With reference to the embodiment of the inventive system in FIG. 9, when the communications device 100 (here a cellular telephone) connects with base station tower or antenna 803 either because cellular telephone 100 initiates a call or answers an incoming call, network or service provider 801 coupled to base station 803 accesses stored information in the database to determine if the communications device is a low-noise device. If it is a low-noise device, the network service provider may either merely take this identity into account to assess an instantaneous network capacity and call volume limit based on the lower infrastructural need of such low-noise devices, and/or may optionally tune the network or the operational characteristics of the device 100 and/or the particular on-going telephone call to take advantage of the low-noise characteristics and operational advantages.

The telephone call or other communication then continues in the conventional manner using either the conventional infrastructure, rules, and policies normally applied. Alternatively, the telephone call may continue using a different set of operating parameters, rules, and/or policies that take advantage of the low-noise telephone characteristics. For example, the voice encoder, discontinuous transmission (DTX), or other operational parameters of the telephone may be modified under program control and/or in response to a signal or signals from the network service provider.

The network service provider may also optionally apply a discount to the telephone call either in terms of a reduced per minute fee, by applying fractional multiplier to the number of minutes charged, by adding bonus minutes to the user's account, or by applying additional discounts, bonuses, or premiums to the user. These discounts, bonuses, premiums, or the like may be applied to the party initiating the call and/or to the party receiving the call where the network provider has an ability to provide such discounts, bonuses, premiums, or the like. Incentives such as purchase rebates or usage discounts may also or alternatively be offered to encourage existing subscribers to upgrade old devices to newer low-noise devices such as those described herein. Therefore, it will be appreciated that the invention also provides a business method or model that encourages users to subscribe to a network service provider that has a lower user cost structure because of the more efficient use of network resources and infrastructure, and that has increased revenues and profit potential. For example, if the network service provider can reduce the per call cost by for example twenty-five percent and only provide a ten-percent cost savings to the customer or subscriber, then the service provider is able to retain the fifteen-percent difference as additional revenue or profit.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

What is claimed is:

1. A method of increasing the volume of calls in a wireless cellular network comprising;
detecting the use of noise reduction devices;
recording in a database the use of each noise reduction device; and
adjusting the number of allowed users of the network in response to the number of noise reduction devices in use.

2. The method of claim 1, wherein the noise reduction device comprises:
a handset including a first microphone outputting voice and environmental or ambient noise;
a second microphone outputting more environmental or ambient noise than the first microphone; and
means to counterbalance or remove the environmental or ambient noise to reduce the noise generated or transmitted by the handset.

3. The method of claim 2, wherein noise is reduced by use of counterbalance, correction signal generator, a multiplication output, and a transmitter having an input connected to the multiplication output and a transmitter output in communication with an antenna and wherein environmental noise picked up by the first microphone and by the second microphone is processed by the environmental noise counterbalanced or correction signal generator and wherein the environmental noise is attenuated before being passed to the transmitter.

4. The method of claim 2, wherein a continuous time computer or discrete time signal processing techniques is used to remove environmental noise from the output of the headset.

5. The method of claim 1, wherein the database is on the network.

6. The method of claim 5, wherein noise reduction handsets are pre-identified in the database.

7. The method of claim 6, wherein a one bit change occurs in the database when a handset is using the network.

8. The method of claim 7, wherein the number of callers on the network are adjusted to take advantage of increased network capacity due to increased signal to noise ratios of noise reduction handsets.

8. The method of claim 7, wherein the number of callers on the network are adjusted to take advantage of increased network capacity due to the decrease in switching rates of the network.

10. The method of claim 7, wherein the number of callers on the network are adjusted to take advantage of increased network capacity due to the decrease in changes of switching rates of the network.

11. The method of claim 1, wherein a database is used to track the number of noise reduction devices on a network.

12. The method of claim 1, wherein calling devices achieve noise reduction by:
detecting a speech signal from a microphone;
detecting a background noise signal from a microphone; and
subtracting the background noise signal from the speech signal.

13. The method of claim 3, wherein an analog sum circuit is used to subtract the background noise signal from the speech signal.

14. The method of claim 3, wherein an analog computer adding circuit if used to subtract the background noise signal from the speech signal.

15. The method of claim 3 wherein the background noise signal is continuously phase shifted or with discrete time signal processing techniques.

16. The method of claim 1, wherein the number of users on a network is adjusted in response to the number of users using noise reduction devices.

17. The method of claim 1, wherein a noise reduction device sends a signal having at least one bit to the database to signal or indicate the use of noise reduction by the handset or device.

18. An apparatus for adjusting the volume of calls on a network comprising:
a database to record the number of users using noise reduction devices; and
means for adjusting the number of users on the network in response to the number of users using noise reduction devices.

19. The apparatus of claim 9, wherein a noise reduction device comprises:
means for detecting background noise;
means for detecting a speech signal; and
means for subtracting the background noise from the speech signal.

20. The method of claim 10, wherein the speech signal is detected by a microphone located relatively close to the speaker's mouth and the background noise is detected by a microphone located relatively further from the mouth of the speaker.

21. The method of claim 10, with means to invert the background noise signal up to 180 degrees.

22. A method of increasing the capacity of a network comprising:
recording the number of noise reducing devices on the network; and
adjusting the number of allowed users on the network.

23. The method of claim 13, wherein the number of allowed users of a network is adjusted in response to the number of noise reducing devices on the network.

24. The method of claim 13, wherein a database on the network is used to mark the use of noise reduction handsets.

25. The method of claim 15, wherein revenue is increased through increases in network capacity.

26. The method of claim 15, wherein the rate of switching in the network is reduced by the use of noise reducing handsets.

27. The method of claim 15, wherein reductions to changes in network switching rates is achieved though the use of noise reducing handsets.

30. An apparatus for adjusting the volume of calls on a communication network comprising:
a database to record the number of users using a particular noise reduction device; and
a controller for modifying the number of callers permitted on the network in response to the number of callers using the particular noise reduction device.

31. The apparatus of claim 30, wherein the particular noise reduction device comprises:
a first detector for detecting at least a background noise signal;
a second detector for detecting at least a speech signal; and
a differencing unit for subtracting the background noise signal from the speech signal to generate a resulting noise reduced speech signal.

32. The apparatus of claim 30, wherein:
the first detector for detecting at least a background noise signal also detects a speech signal component;
the second detector for detecting at least a speech signal also detects a background signal component;
the second detector positioned to detect a larger speech signal component than the first detector; and
the differencing unit for subtracting the background noise signal from the speech signal to generate a resulting noise reduced speech signal being operative to generate the resulting noise reduced speech signal from the signals detected at the first and second detectors.

33. A method of increasing the number of separate communications in a communications network, the method comprising;
predicting the use of a low data rate communications device on the communications network;
recording in a database the identity of the low data rate communications device; and
adjusting the number of allowed users on the communications network in response to the number of low data rate devices.

34. A method as in claim 33, wherein the predicting of the use of a low data rate communications device on the network comprises detecting an actual use of a low data rate communications device on the network.

35. A method as in claim 33, wherein the recording in a database the identity of the low data rate communications device comprises recording in a database the identity of the low data rate device when the low data rate communications device is in use on the network.

36. A method as in claim 33, wherein the adjusting of the number of allowed users on the communications network in response to the number of low data rate devices comprises adjusting of the number of allowed users on the communications network in response to the number of low data rate devices identified in the database.

37. A method as in claim 33, wherein the adjusting of the number of allowed users on the communications network in response to the number of low data rate devices comprises adjusting of the number of allowed users on the communications network in response to the number of low data rate devices in use on the network at the time of the adjustment.

38. A database coupled to a communications network, the database comprising:
a storage device storing an identifier associated with a physical communication device and a data-rate indicator that indicates at least that the physical communication device associated with the identifier is capable of low data rate communications; and
the storage device coupled with the communications network or with a management network access system for determining the number of communications devices identified as having low data rate communications capability.

39. A database as in claim 38, further comprising a processor coupled with the database for processing data items stored within the database.

40. A database as in claim 39, wherein the processor executes a computer program for generating statistical information with respect to the number of callers making calls on the network using noise reduced and/or cancellation enabled cellular telephones.

41. A database as in claim 40, wherein the processor executes a computer program for querying and controlling the database and communicating with the network.
